(19) United States
(12) Patent Application Publication
(10) Pub. No.: US 2007/0100906 A1
(43) Pub. Date: May 3, 2007

(54) Method for synchronizing two sets of contact data of two storage media in a communications system

(75) Inventors: Ann-Tzung Cheng, Taipei City (TW); Meng-Shan Lin, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/590,795

(22) Filed: Nov. 1, 2006

(30) Foreign Application Priority Data
Nov. 3, 2005 (TW) 094138579

(51) Int. Cl. G06F 17/30

(52) U.S. Cl. 707/201

(57) ABSTRACT

A method establishes two contact data arrays in two separate storages respectively and corresponding mapping relations between the two contact data arrays. The method updates the content of the contact data of one storage medium with the content of the contact data of the other storage medium according to the corresponding mapping relations between the two contact data arrays and to the choice of an operator that can update one of a plurality of contact data with one or more of a plurality of contact data.

### BACKGROUND OF THE INVENTION

1. Field of the Invention

The present invention relates to a method for synchronizing contact data, and more specifically, to a method for synchronizing two sets of contact data of two storage media in a communications system.

2. Description of the Prior Art

The phone book in a typical mobile phone has grown far more in capacity and in variety of content that can be stored in a subscriber identity module (SIM) card.

Inconsistency of stored data occurs between the phone book and the SIM card due to the long-term user preference of using the phone book. If the mobile phone is to be replaced by another one and the same SIM card is to be used, the contact data in the SIM card may likely be wrong, be out of date, or incomplete. The prior art provides no convenient tools for updating contact data on the mobile phone to the SIM card. The user can only compare contact data one by one between the phone book and the SIM card and manually correct data in the SIM card, which is a time consuming job.

On the other hand, if an update gets more complicated, such as one concerning updating between different SIM cards or between multiple SIM cards and a phone book, there is also no such tool for this tedious job in the prior art. Even though functions such as duplication are provided by the conventional mobile phone book to copy data in the SIM card to the mobile phone book, duplicate data or data having different time history can exist in the phone book, and such piecewise data duplication is certainly wasteful in memory and bothersome to the user.

### SUMMARY OF THE INVENTION

The claimed invention provides a method for synchronizing two sets of contact data of two storage media in a communications system. The method comprises establishing a first contact data array according to contact data of a first storage medium and establishing a second contact data array according to contact data of a second storage medium; establishing mapping relations between the contact data of the first contact data array and the contact data of the second contact data array according to the first contact data array and the second contact data array; and updating content of a second contact datum of the second storage medium with content of a first contact datum of the first storage medium according to the mapping relations between the contact data of the first contact data array and the contact data of the second contact data array.

The claimed invention also provides a communications system capable of synchronizing contact data. The communications system comprises a first storage device having a plurality of contact data; a second storage device having a plurality of contact data; a first contact data array stored in the first storage device, the first contact data array having a plurality of pointers pointing to the plurality of contact data stored in the first storage device; a second contact data array stored in the second storage device, the second contact data array having a plurality of pointers pointing to the plurality of contact data stored in the second storage device; and a synchronization module for establishing mapping relations between the plurality of contact data of the first contact data array and the plurality of contact data of the second contact data array according to the first contact data array and the second contact data array and for updating content of the contact data of the second storage device with content of the first contact data of the first storage device according to the mapping relations between the plurality of contact data of the first contact data array and the plurality of contact data of the second contact data array.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 are illustrations of a data building stage of a method for synchronizing two sets of contact data of two storage media in a communications system according to the present invention.

FIG. 4 is an illustration of an exemplary embodiment of the data building stage according to the present invention.

FIG. 5 is an illustration of a data synchronizing stage of a method according to the present invention.

FIG. 6 is an illustration of synchronization types when synchronizing contact data according to the present invention.

FIG. 7 is an illustration of a synchronization method that updates the first contact data to the second contact data.

FIG. 8 is an illustration of an communications system capable of synchronizing contact data according to the present invention.

### DETAILED DESCRIPTION

The method according to the present invention has two stages: the data building stage and the data synchronizing stage. The present invention relates to synchronizing contact data between a first storage medium and a second storage medium. In the following description, a phone book of a communications system (abbreviated as “the phone book”) is taken as the first storage medium and a SIM card for plugging into the communications system is taken as the second storage medium. The present invention also considers the way of synchronization as updating data of the first storage medium (the phone book) to the second storage medium (the SIM card).

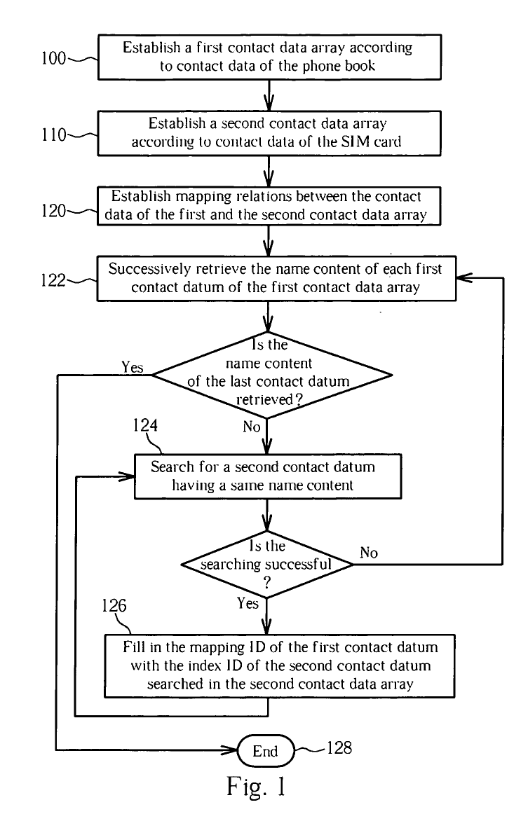

Please refer to FIG. 1 to FIG. 3, which are illustrations of the data building stage of the method for synchronizing two sets of contact data of two storage media in a communications system according to the present invention. The data building stage has the following steps:
Step 100: Establish a first contact data array according to contact data of the phone book;
Step 110: Establish a second contact data array according to contact data of the SIM card;
Step 120: Establish mapping relations between the contact data of the first contact data array and the contact data of the second contact data array.

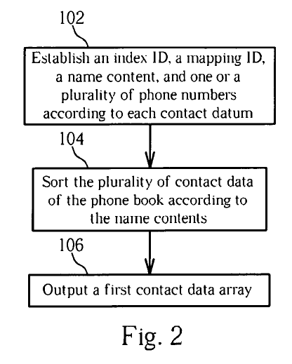

To perform the synchronization between the phone book and the SIM card, two contact data arrays in each storage medium must be built for comparison. The data build-up is performed when the system is initiated, i.e., when the communications system is turned on, or performed when a user activates the phone book of the mobile phone since to build the contact data array takes system resources. As Step 100 shows, an index ID, a mapping ID, a name content, and a phone number content of each of a plurality of contact data are established in a phone book with the plurality of contact data. The index ID is a unique ID stored in the first contact data array, the name content and the plurality of phone number contents are data pre-stored in the phone book, and the mapping ID keeps information of mapping relations between the contact data of the phone book and the contact data of the SIM card. After the plurality of contact data are established respectively in the phone book and the SIM card, each plurality of contact data are sorted according to the respective name content of the contact data to establish the mapping relations in the following step. Please refer to FIG. 2. The steps of establishing the first contact data array of the phone book are as follows:
Step 102: establish an index ID, a mapping ID, a name content, and one or a plurality of phone numbers according to each contact datum of the phone book;
Step 104: sort the plurality of contact data of the phone book according to the name contents;.
Step 106: output the plurality of sorted contact data as a first contact data array.

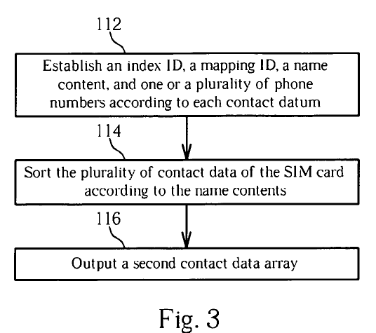

Please refer to FIG. 3, wherein the steps of establishing the second contact data array of the SIM card are as follows:
Step 112: establish an index ID, a mapping ID, a name content, and one or a plurality of phone numbers according to each contact datum of the SIM card;
Step 114: sort the plurality of contact data of the SIM card according to the name contents;
Step 116: output the plurality of sorted contact data as a second contact data array.

Then the method according to the embodiment of the present invention establishes mapping relations between the two contact data arrays as step 120 shows. The mapping relations from the second contact data array of the SIM card to the first contact array of the phone book are established in the first place, which are introduced as follows:
Step 122: successively retrieve the name content of each first contact datum of the first contact data array, and perform Step 128 if the name content of the last contact datum is retrieved;
Step 124: search for a second contact datum in the second contact data array having a name content the same as the name content of a first contact datum according to the name content of the contact data of the first contact data array in Step 122; if the searching is unsuccessful, perform Step 122 to retrieve a next first contact datum;
Step 126: if the searching results in a match, then fill in the mapping ID of the first contact datum with the index ID of the second contact datum searched in the second contact data array and perform Step 124;
Step 128: end.

During the establishing stage, there may be more than one second contact datum in the second contact data array having a same name content as the name content of one of each first contact datum, and therefore the mapping ID of the first contact datum may store index IDs of more than one second contact datum. Those first contact data not having content identical to that of the contact data in the SIM card have blank mapping IDs.

The embodiment of the present invention has similar way to establish mapping relations from the first contact data array of the phone book to the second contact array of the SIM card, which establishes mapping relations in reverse direction to that mentioned above.

Similarly, during the establishing stage, there may be more than one first contact datum in the first contact data array having a same name content as the name content of one of each second contact datum, and therefore the mapping ID of the second contact datum may store index IDs of more than one first contact datum. Those second contact data having no identical name content as that of the contact data in the phone book have blank mapping ID.

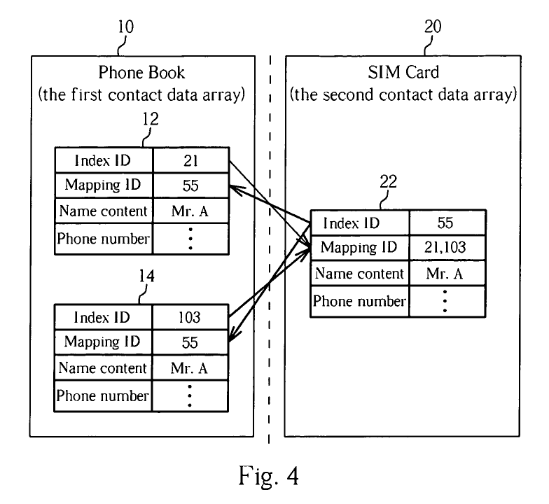

Please refer to FIG. 4, which is an illustration of an exemplary embodiment of the data building stage according to the present invention. For example, if two pieces of contact data 12, 14 have a same name content, “Mr. A”, in the first contact data array of the phone book 10, where the two contact data have index IDs “21” and “103”, and a contact datum 22 having a name content “Mr. A” is found in the second contact data array of the SIM card 20, where the contact datum 22 has index ID “55”, then during Steps 122 to 126, the mapping IDs of the contact data 12, 14 will be filled with the number “55” as a pointer to the contact datum 22 having index ID “55” in the second contact data array. During Steps 132 to 136, the mapping ID of the contact data 22 will be filled with the numbers “21” and “103” as pointers to the contact data 12 and 14 having index IDs “21” and “103” respectively in the first contact data array. In such way, the mapping relations between the first contact data array and the second contact data array are established.

Additionally, sorting the contact data in the phone book and the SIM card according to the name content respectively in Step 104 and Step 114 allows a local search of sorted contact data to perform Step 124, which further reduces time for searching data to establish mapping relations.

After the contact data arrays of the phone book and the SIM card, and the mapping relations are established, the contact data of the two storage media will be compared and updated in the data synchronizing stage. In the data synchronizing stage, the data updating directly modifies contact data of the phone book of the SIM card. In fact, the first and the second contact data arrays are pointers to physical data on the storage media, in that updating data in the contact data array updates physical data in the storage medium. However, there can a first or a second contact data array having physical data if the phone book or the SIM card has sufficient memory. In such way, data in the two contact data arrays is processed when updating, and after completion of updating or confirmation or updating from a user, and the updated data is written in the phone book and the SIM card. A data updating procedure with higher safety is thus provided.

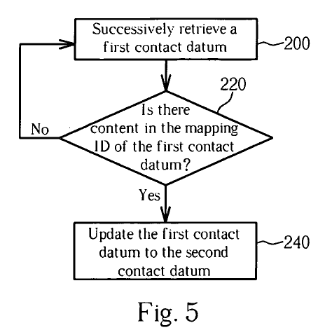

Please refer to FIG. 5, which is an illustration of a data synchronizing stage of the method according to the present invention. The steps of updating contact data of the phone book to the SIM card are as follows:
Step 200: successively retrieve a first contact datum of the first contact data array of the phone book;
Step 220: search the content of the mapping ID of the retrieved first contact datum; if the content is missing, perform Step 200 to retrieve a next first contact datum;
Step 240: if the mapping ID searched in Step 220 is not blank, update the first contact datum to the second contact datum.

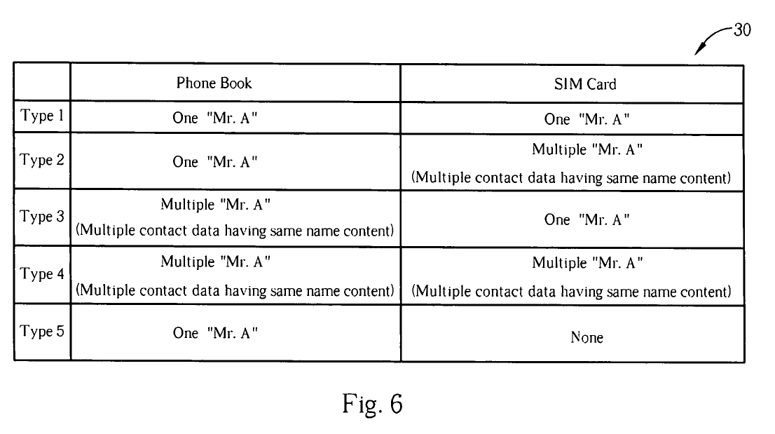

Five types of synchronization are introduced in the following paragraphs according to the present invention. Taking a contact datum having name content of “Mr. A” and updating contact data from the phone book to the SIM card for example, the five types of synchronization are shown in FIG. 6 as follows:

Type 1: both the phone book and the SIM card have only one contact datum A1 and A2 having name content “Mr. A”. In this type, replace the phone number of contact datum A2 of the SIM card with the phone number of contact datum A1 of the phone book.

Type 2: the phone book has a contact datum having name content “Mr. A” and the SIM card has multiple pieces of contact data having name content “Mr. A”. For example, the SIM card has three pieces of contact data A2(55), A2(72), and A2(83) having name content “Mr. A”, which means in Step 220, the mapping ID of the first contact datum has three index IDs that point to the second contact data array. This is a “one-to-many mapping relation”. In this type of synchronization, the user selects one or more among contact data A2(55), A2(72), and A2(83) for synchronization and replaces the phone number of the selected one or many pieces of contact data in the SIM card with the phone number of the “Mr. A” contact data in the phone book.

Type 3: the phone book has multiple pieces of contact data having name content “Mr. A” and the SIM card has one contact datum having name content “Mr. A”. For example, the phone book has two pieces of contact data A1(21) and A1(103) having name content “Mr. A”, which means in Step 220, a mapping ID with a single index ID “55” of the first contact datum A1(21) is found. When checking the mapping ID of the contact datum A2(55) of the SIM card, the contact datum A2(55) containing only index ID “21” indicates a “one-to-one mapping relation” as Type 1 describes. In Type 3, the contact datum A2(55) contains index IDs “21” and “103”, and is classified as a “many-to-one mapping relation”. In such case, the user selects one contact datum from contact data A1(21) or A1(103) for synchronization and the method according to the present invention replaces the phone number of the contact datum A2(55) of the SIM card with the phone number of the selected contact datum (for example, the contact datum A1(21)) to complete updating. The contact datum A1(103) can be either left alone or copied to the SIM card.

Type 4: the phone book has multiple contact data having name content “Mr. A”, for example, two contact data named A1(21) and A1(103), and the SIM card has multiple contact data having name content “Mr. A”, for example, three contact data named A2(55), A2(72), and A2(83). This means in Step 220, when finding the first contact datum having name content “Mr. A” whose mapping ID has three index IDs “55”, “72”, and “83”, the method checks the mapping ID of the first corresponding contact datum A2(55) in the SIM card and identifies “21” and “103” as the content. Therefore, this type can be classified as a “many-to-many mapping relation”. In this type of synchronization, the user selects contact data that is to be synchronized in A1 and A2 respectively, for example, if A1(21) and A2(72) are selected, it means the synchronization replaces the phone number of contact datum A2(72) with the phone number of contact datum A1(21). It can also exclude contact data in A1 and A2 that have the same phone number and requires no synchronization. The remaining contact data in A1 and A2 are selected among for synchronization.

The above mentioned type 2 to type 4 synchronization all select among a plurality of contact data for synchronizing; therefore, the method is capable of further storing the selection of the mapping ID (the selection represents a mapping relation), and setting the selection (the mapping relation) as a default way of synchronization at the next synchronization for simplicity. The user can also select a new mapping relation each time of synchronization.

In addition to the four types of synchronization discussed above, a type 5 synchronization is described as followed:

Type 5: the phone book has a contact datum having name content “Mr. A” while no contact datum having the same name content exists in the SIM card. The user determines whether to copy the contact datum having name content “Mr. A” in the phone book to the SIM card, and whether to update the contact datum having name content “Mr. A” in the SIM card when the contact datum having name content “Mr. A” in the phone book is renewed.

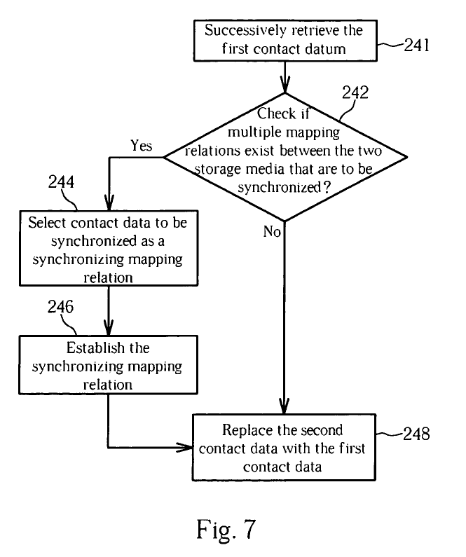

Please refer to FIG. 7, which is an illustration of a synchronization method that updates the first contact data to the second contact data in Step 240. The steps of FIG. 7 are as follows:
Step 241: successively retrieve the first contact datum;
Step 242: check if multiple mapping relations exist between the two storage media that are to be synchronized; if multiple mapping relations do not exist, perform Step 248;
Step 244: select contact data to be synchronized as a synchronizing mapping relation;
Step 246: establish the synchronizing mapping relation according the Step 244;
Step 248: replace the second contact data with the first contact data.

According to the present invention, a user can determine to either store updated contact data in the phone book to the corresponding contact data in the SIM card when the contact data in the phone book is updated, or be prompted to synchronously store the updated contact data to the SIM card. It is just for descriptive convenience that in this description, the method deals with updating contact data in the phone book to the SIM card. Updating contact data in the SIM card to the phone book is done in substantially the same way.

The present invention discloses a method for synchronizing two sets of contact data in a phone book and a SIM card in a communications system. In fact, the method of data synchronization according to the present invention applies to any case of synchronizing contact data in two storage media, such as two phone books in two mobile devices, or two sets of contact data in two SIM cards.

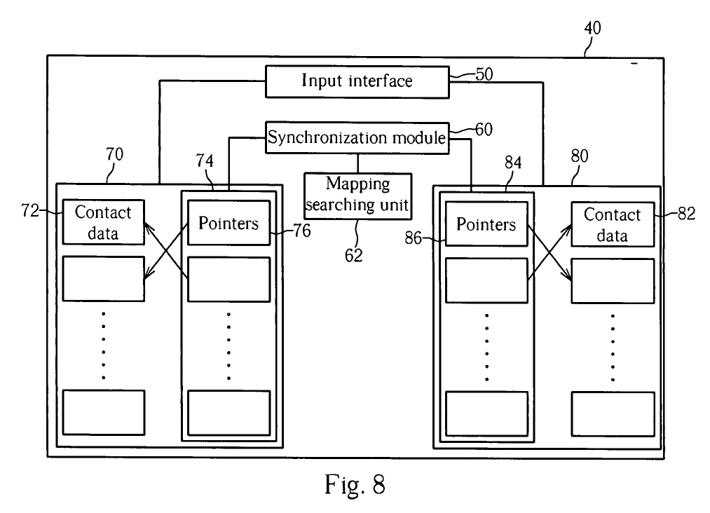

Please refer to FIG. 8, which is an illustration of a communications system 40 capable of synchronizing contact data according to the present invention. The communications system 40 comprises a first storage device 70, a second storage device 80, a synchronization module 60, and a mapping searching unit 62. The first storage device 70 comprises a plurality of contact data 72 and a first contact data array 74. The second storage device 80 comprises a plurality of contact data 82 and a second contact data array 84. The synchronization module 60 is for updating content of the contact data 82 of the second storage device 80 with content of the first contact data 72 of the first storage device 70.

The first contact data array 74 comprises a plurality of pointers 76 pointing to the plurality of contact data 72 in the first storage device 70. The second contact data array 84 comprises a plurality of pointers 86 pointing to the plurality of contact data 82 in the second storage device 80. The synchronization module 60 is coupled between the first contact data array 74 and the second contact data array 84, and with the mapping searching unit 62 coupled with the synchronization module 60, the synchronization module 60 establishes mapping relations between contact data of the first contact data array 74 and the second contact data array 84. The synchronization module 60 establishes mapping relations between the plurality of contact data 72 pointed to by the first contact data array 74 and the plurality of contact data 82 pointed to by the second contact data array 84 according to the first contact data array 74 and the second contact data array 84, and updates content of the second storage device 80 with contact data 72 of the first storage device 70 according to mapping relations between the plurality of contact data 72 pointed to by the first contact data array 74 and the plurality of contact data 82 pointed to by the second contact data array 84.

The communications system 40 further comprises an input interface 50 coupled between the first storage device 70 and the second storage device 80 for inputting contact data into the first storage device 70 or the second storage device 80.

The present invention establishes two contact data arrays in two separate storage mediums and corresponding mapping relations between the two contact data arrays. The method updates content of the contact data of one storage medium with content of the contact data of the other storage medium according to the corresponding mapping relations between the two contact data arrays and to the choice of an operator that can update one of a plurality of contact data with one or more of a plurality of contact data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for synchronizing two sets of contact data of two storage media in a communications system, comprising:
establishing a first contact data array according to contact data of a first storage medium and establishing a second contact data array according to contact data of a second storage medium;
establishing mapping relations between the contact data of the first contact data array and the contact data of the second contact data array according to the first contact data array and the second contact data array; and
updating content of a second contact datum of the second storage medium with content of a first contact datum of the first storage medium according to the mapping relations between the contact data of the first contact data array and the contact data of the second contact data array.

2. The method of claim 1 wherein establishing the first contact data array according to the contact data of the first storage medium and establishing the second contact data array according to the contact data of the second storage medium comprises:
establishing in the first contact data array and in the second contact data array respectively an index ID, a mapping ID, a name content, and a phone number content of one of a plurality of contact data; and
sorting the plurality of contact data of the first contact data array and the plurality of contact data of the second contact data array respectively according to the respective name content of the contact data.

3. The method of claim 2 wherein establishing the mapping relations between the contact data of the first contact data array and the contact data of the second contact data array according to the first contact data array and the second contact data array comprises:
searching for a second contact datum in the second contact data array having a name content the same as a name content of a first contact datum according to the name content of the contact data of the first contact data array; and
filling in the mapping ID of the first contact datum of the first contact data array with the index ID of the second contact datum searched in the second contact data array with the same name content as the name content of the first contact datum.

4. The method of claim 1 wherein updating content of a second contact datum of the second storage medium with content of a first contact datum of the first storage medium according to the mapping relations between the contact data of the first contact data array and the contact data of the second contact data array comprises:
selecting one mapping ID of the first contact datum and updating the content of the second contact datum having an index ID as the selected mapping ID of the first contact datum when a plurality of mapping IDs exists in the first contact datum of the first storage medium; and
storing the selection of the mapping ID.

5. The method of claim 4 further comprising updating the content of the second contact datum having the index ID as the selected mapping ID with the content of the first contact datum according to the stored selection of the mapping ID when the content of the first contact datum updates.

6. The method of claim 1 wherein updating content of a second contact datum of the second storage medium with content of a first contact datum of the first storage medium according to the mapping relations between the contact data of the first contact data array and the contact data of the second contact data array comprises:
selecting one mapping ID of the second contact datum and updating the content of the second contact datum with the content of the first contact datum having an index ID as the selected mapping ID of the second contact datum when a plurality of mapping IDs exists in the second contact datum of the second storage medium; and
storing the selection of the mapping ID.

7. The method of claim 6 further comprising updating content of the second contact datum having an index ID as the selected mapping ID with content of the first contact datum according to the stored selection of the mapping ID when the content of the first contact datum updates.

8. The method of claim 1 further comprising adding a contact datum from the first storage medium having no mapping relation to the second storage medium.

9. The method of claim 1 wherein establishing the first contact data array according to the contact data of the first storage medium and establishing the second contact data array according to the contact data of the second storage medium is performed when the communications system starts or when the contact data of the first storage medium are activated.

10. The method of claim 1 further comprising updating the first contact datum to the second storage medium when the first contact datum of the first storage medium is updated.

11. The method of claim 1 further comprising updating the second contact datum of the second storage medium having a corresponding mapping relation with the first contact datum when the first contact datum of the first storage medium is updated.

12. The method of claim 1 further comprising selecting to update or not to update the second contact datum of the second storage medium having a corresponding mapping relation with the first contact datum when the first contact datum of the first storage medium is updated.

13. A communications system capable of synchronizing contact data, comprising:
a first storage device having a plurality of contact data;
a second storage device having a plurality of contact data;
a first contact data array stored in the first storage device, the first contact data array having a plurality of pointers pointing to the plurality of contact data stored in the first storage device;
a second contact data array stored in the second storage device, the second contact data array having a plurality of pointers pointing to the plurality of contact data stored in the second storage device; and
a synchronization module for establishing mapping relations between the plurality of contact data of the first contact data array and the plurality of contact data of the second contact data array according to the first contact data array and the second contact data array and for updating content of the contact data of the second storage device with content of the first contact data of the first storage device according to the mapping relations between the plurality of contact data of the first contact data array and the plurality of contact data of the second contact data array.

14. The communications device of claim 13 further comprising an input interface coupled with the first storage device and the second storage device for inputting contact data into the first storage device or the second storage device.

15. The communications device of claim 13 further comprising a mapping searching unit coupled with the synchronization module for searching the mapping relations between the contact data of the first contact data array and the second contact data array.
